(19) United States
(12) Patent Application Publication
(10) Pub. No.: US 2008/0295676 A1
(43) Pub. Date: Dec. 4, 2008

(54) PREAMP FOR USE WITH A MUSICAL INSTRUMENT AND ELECTRIC INSTRUMENT

(75) Inventor: Yasuyuki YAMADA, Hamamatsu-city (JP)

Correspondence Address: FOLEY & LARDNER, 2029 CENTURY PARK EAST, SUITE 3500, LOS ANGELES, CA, 90067, US

(73) Assignee: ROLAND CORPORATION

(21) Appl. No.: 12/184,091

(22) Filed: Jul. 31, 2008

Related U.S. Application Data
(62) Division of application No. 11/342,312, filed on Jan. 27, 2006.

(30) Foreign Application Priority Data
Jan. 31, 2005 (JP) 2005-023466

(51) Int. Cl. G10H 3/12

(52) U.S. Cl. 84/741

(57) ABSTRACT

A preamp for use with a musical instrument includes a processing circuit that processes an electrical signal and an output device that outputs the electrical signal to an external device. The preamp also includes a battery that supplies electric power to the processing circuit. A switch switches in those cases where a voltage of the battery has dropped below a specific voltage, such that the electrical signal is output from the output device instead of an output of the processing circuit.

### CROSS-REFERENCE TO RELATED PATENT APPLICATIONS

Japan Priority Application 2005-023466, filed Jan. 31, 2005 including the specification, drawings, claims and abstract, is incorporated herein by reference in its entirety.

### BACKGROUND OF THE INVENTION

1. Field of the Invention

Embodiments of the present invention relate to a preamp for use with a musical instrument that processes an output of a pickup of a stringed musical instrument and to an electronic instrument.

2. Related Art

For some time, preamps for use with an electric instrument have been known in which a pickup that detects the vibrations of the strings is mounted on the body of a stringed instrument such as a guitar and the like. The preamps possess a volume control that adjusts the output level of the pickup and a connector that connects a connecting cord for transmitting the electrical signal to the outside and the like. This kind of preamp for use with an electric instrument (there are also cases in which this is called an effector) is usually installed in the electric instrument or independent from the electric instrument and the output is, in most cases, connected to a main amp or a guitar amp.

In U.S. Pat. No. 5,693,898, a configuration is disclosed with this configuration in which a preamp that has power supplied from a battery is installed in an acoustic guitar. It is possible to carry out audio processing such as amplifying or adding effects to the vibrations of the strings of the acoustic guitar with the preamp. Particularly in cases where the battery is depleted and the voltage has dropped, it is possible to replace the battery with a simple operation.

However, with the conventional preamps for use with an electric instrument in cases where the battery has become depleted and the voltage has dropped, the sound becomes distorted or there is no output of sound. In particular, there has been the problem that when the voltage of the battery drops during a performance, this becomes an impediment to the performance.

### SUMMARY OF THE INVENTION

Embodiments of the present invention address the problems described above and relate to a preamp for use with a musical instrument as well as an electronic instrument that does not become an impediment even in cases where the voltage of the battery has dropped.

A preamp for use with a musical instrument according to an embodiment of the present invention includes an input device that inputs an electrical signal and a processing circuit that processes the electrical signal that has been input in the input device. An output device outputs the electrical signal that has been processed by the processing circuit to an external device and a battery supplies electric power to the processing circuit. A switching device switches, in those cases where the voltage of the battery has dropped below a specified voltage, such that the electrical signal that has been input in the input device is output from the output device instead of the output of the processing circuit. The specified voltage is roughly the lowest operating voltage at which the processing circuit operates normally.

A preamp for use with a musical instrument according to another embodiment of the present invention includes an input device that inputs an electrical signal and a processing circuit that processes the electrical signal that has been input in the input device. An output device outputs the electrical signal that has been processed by the processing circuit to an external device and a battery supplies electric power to the processing circuit. A single switching device switches such that the electrical signal that has been input in the input device is output from the output device instead of the output of the processing circuit and, stops the supply of electric power to the processing circuit by the battery.

The processing circuit also includes a level adjustment device that adjusts the output level of the electrical signal that has been input in the input device. The processing circuit further includes an effect imparting device that imparts a specific effect to the electrical signal that has been input in the input device and a frequency characteristics changing device that changes the frequency characteristics of the electrical signal that has been input in the input device.

An electric instrument according to another embodiment of the present invention includes a plurality of strings and a pickup that is arranged facing the strings and converts the vibrations of the strings into an electrical signal. A processing circuit is included that inputs the electrical signal that has been converted by the pickup and processes the electrical signal that has been input. An output device is provided that outputs the electrical signal that has been processed by the processing circuit to an external device and a battery supplies electric power to the processing circuit. A switching device is included which, in those cases where the voltage of the battery has dropped below a specified voltage, switches such that the electrical signal that has been converted by the pickup is output from the output device instead of the output of the processing circuit. The specified voltage is roughly the lowest operating voltage at which the processing circuit operates normally.

An electric instrument according to a further embodiment of the present invention includes a plurality of strings and a pickup that is arranged facing the strings and converts the vibrations of the strings into an electrical signal. A processing circuit is included that inputs the electrical signal that has been converted by the pickup and processes the electrical signal that has been input. An output device is provided that outputs the electrical signal that has been processed by the processing circuit to an external device and a battery supplies electric power to the processing circuit. A single switching device switches such that the electrical signal that has been converted by the pickup is output from the output device instead of the output of the processing circuit and stops the supply of electric power to the processing circuit by the battery.

The processing circuit includes a level adjustment device that adjusts the output level of the electrical signal that has been converted by the pickup, an effect imparting device that imparts a specific effect to the electrical signal that has been converted by the pickup and a frequency characteristic changing device that changes the frequency characteristics of the electrical signal that has been converted by the pickup.

### BRIEF DESCRIPTION OF THE DRAWINGS

FIG. 1 is an oblique view drawing that shows an acoustic guitar incorporating a preamp for use with a musical instrument according to an embodiment of the present invention.

FIG. 2 is a planar drawing that shows the operating panel of the preamp for use with a musical instrument according to an embodiment of the present invention.

FIG. 3 is a circuit diagram that shows the electrical configuration of the preamp for use with a musical instrument according to an embodiment of the present invention.

FIG. 4 is a block diagram that shows the configuration of the processing circuit that is installed in the preamp for use with a musical instrument according to an embodiment of the present invention.

### DETAILED DESCRIPTION OF THE PREFERRED EMBODIMENTS

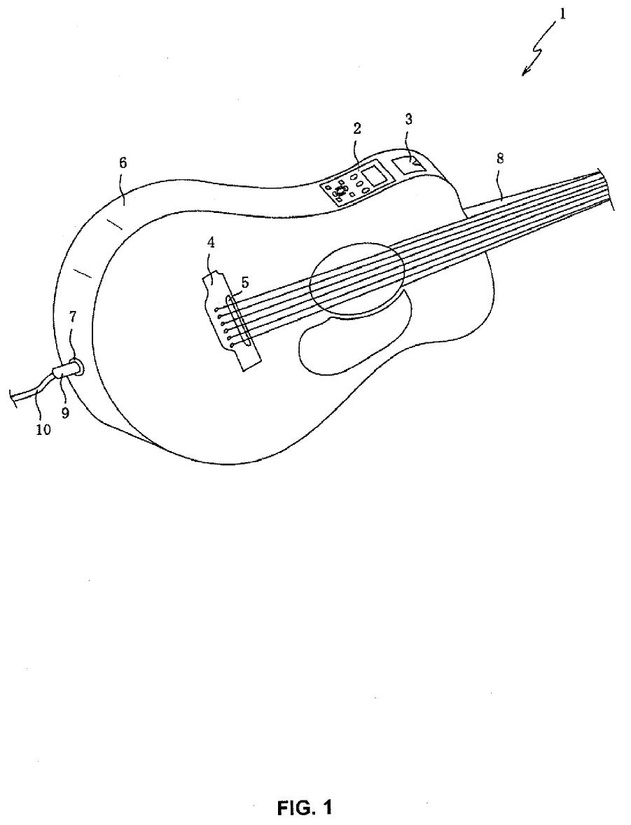

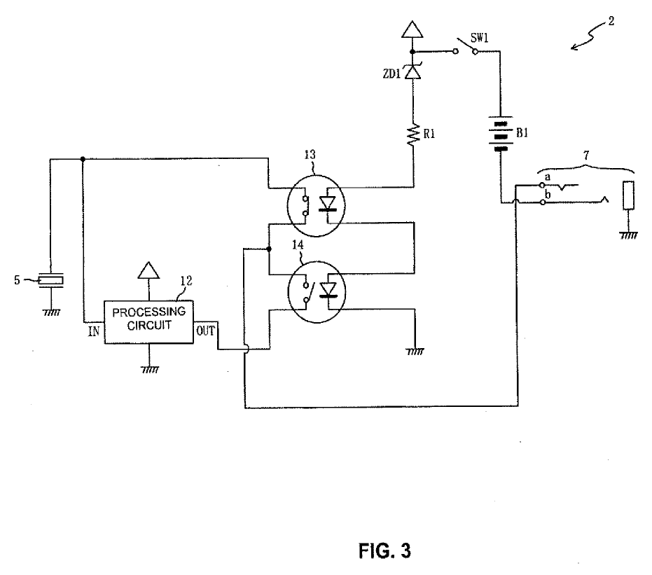

An explanation will be given below regarding embodiments of the present invention while referring to the attached drawings. FIG. 1 is an oblique view drawing that shows the acoustic guitar 1 in which the preamp for use with a musical instrument 2 according to an embodiment of the present invention has been installed. As is shown in FIG. 1, the acoustic guitar 1 includes a body 6 that forms a hollow space in which the vibrations of the strings resonate. The preamp for use with the musical instrument 2 is installed in the body 6. A battery case 3 houses a battery B1 (refer to FIG. 3), which supplies power to the preamp for use with the musical instrument 2. A bridge 4 anchors one end of the six strings and a pickup 5 converts the vibrations of each of the strings into an electrical signal is formed on the bridge 4 and converts the vibrations of each of the strings to an electrical signal. As illustrated, an output jack 7 with which the electrical signal that has been converted by the pickup or the electrical signal that has been processed by the preamp for use with a musical instrument 2 is also provided. A neck 8 has a fingerboard for pressing the strings at specified locations. At the other end of the neck 8, which is not shown in the drawing, turning pegs are formed and the pegs are formed so as to impart tension to the strings.

The battery case 3 is formed so that it is possible to install commercial dry batteries in a plurality that is freely removable. A cover that can be opened and closed is attached. A piezoelectric pickup that utilizes a piezoelectric element is used for the pickup 5. The plug 9, which is freely removable, is mounted in the output jack 7 and the electrical signal is output to a guitar amp, which is not shown in the drawing, by the connecting cord 10 that is connected to the plug 9.

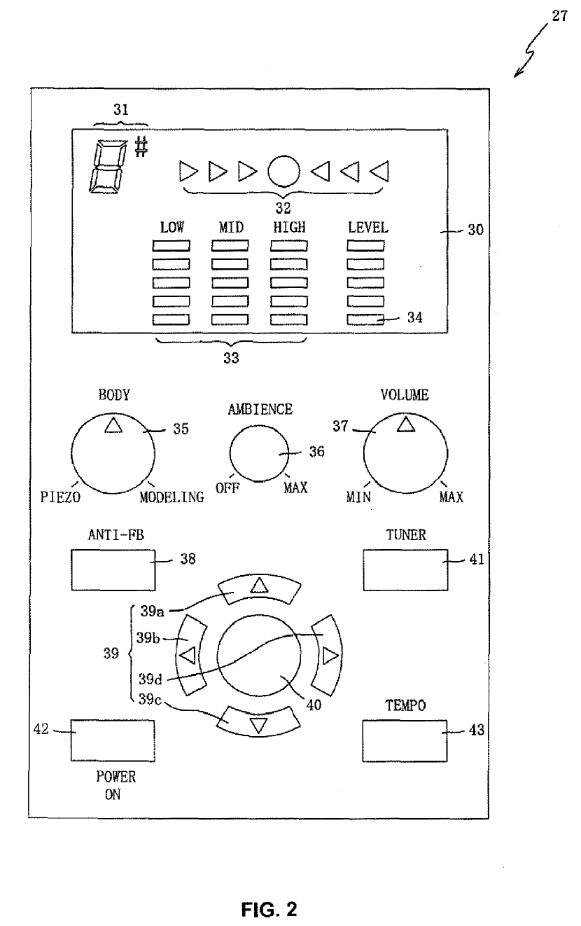

Next, an explanation will be given regarding the operating panel 27 of the preamp for use with a musical instrument 2 while referring to FIG. 2. The preamp for use with a musical instrument 2 includes a processing circuit 12 (refer to FIG. 3) that processes an audio signal, which will be discussed later, and is furnished with a tuner function that detects the pitch of the audio signal that has been input. An equalizer function is provided that converts the frequency characteristics and an effect imparting function is provided that imparts effects such as reverberations and other effects.

The operating panel 27 is furnished with a display device 30 that is formed using a liquid crystal, a body knob 35, an ambience knob 36 and volume knob 37 that adjusts the parameters by rotating. Operating panel 27 also includes an anti-feedback button 38, four cursor buttons 39a, 39b, 39c and 39d, a center button 40 that is located in the middle of the four cursor buttons, a tuner button 41, a power button 42 and a tempo button 43, which directs the switching on and off of the preamp.

The display device 30 includes a pitch notation display section 31 with which, when the pitch of the audio signal that is input is detected in those cases where the tuner function has been turned on by the tuner button 41. The pitch notation that corresponds to that pitch is displayed. The pitch display section 32 displays the divergence of the pitch that has been detected with respect to the pitch of the pitch notation that has been displayed. The equalizer display section 33 displays the levels of the three frequency bands and the level display section 34 displays the level of the audio signal that is input.

The body knob 35 adjusts the strength of the resonance for the effect in which the resonance of the body of a guitar is simulated, which is one of the effect imparting functions. The strength of the resonance increases as the knob is turned to the right. The audio signal is output without the imparting of any resonance at all, when the knob is turned to the left towards the position shown as PIEZO.

The ambience knob 36 adjusts the amount of reverberation and the volume knob 37 adjusts the output level of the preamp for use with the musical instrument 2.

The types of parameters that can be set by the cursor buttons 39a-39d and the center button 40 change depending on the functions that are set. As shown in FIG. 2, cursor button 39a is arranged on the top, cursor button 39b is arranged on the left side, cursor button 39c is arranged on the bottom and cursor button 39d is arranged on the right side.

The anti-feedback button 38 turns a howling prevention function on and off. In those cases where the howling prevention function is turned on, the frequency that is causing the howling is detected and the level of that frequency is lowered. The tuner button 41 switches a tuner function on and off and when the button is pressed continuously for two seconds or more, it is possible to set the standard pitch to be variable. In those cases where the standard pitch has been set to be variable, the standard pitch can be changed higher by the cursor button 39a or the cursor button 39b and the standard pitch can be changed lower by the cursor button 39c or the cursor button 39d.

The tempo button 43 turns on and off the display that represents the temp of the audio signal. In those cases where the tempo buttons 43 has been turned on, the display of the display device 30 is switched to the tempo display screen not shown in the drawings. The display is changed in conformance with the tempo of the audio signal and a piezoelectric element is driven such that a musical tone that communicates the tempo is generated. Ten types are stored for the tempo values, and it is possible to select any one by the operation of the cursor buttons 39b or 39d.

In addition, it is possible to vary the tempo faster by the operation of the cursor button 39a and slower by the operation of the cursor button 39c. Also, it is possible to set the tempo value by operating the center button 40 to the time interval that corresponds to the tempo.

In those cases where the tuner function and the tempo function have not be turned on, the center button 40 can set the equalizer function on and off. When the equalizer function is turned on, it is possible to select any of the three frequency bands of the equalizer section 33 that are displayed on the display device 30 using the cursor button 39b or 39d. The level of the frequency band that has been selected higher with the cursor button 39a and lower with the cursor button 39c can also be set. The power button 42 is an on/off switch that sets whether or not the power of the battery B1 is supplied to the processing circuit 12. When the button is pressed down, the button is locked in the on state and when the button is pressed down again, the off state is restored.

Next, an explanation will be given regarding the electrical circuit configuration of the preamp for use with a musical instrument 2 according to an embodiment of the present invention while referring to FIG. 3. FIG. 3 is a circuit diagram that shows the electrical circuit configuration of the preamp for use with a musical instrument 2 which includes, the output jack 7, the battery B1, a power switch SW1, a Zener diode ZD1, a resistor R1, a photo relays 13 and 14, the processing circuit 12, and the pickup 5.

The output jack 7 is furnished with a terminal “a” that is connected to the output of the preamp for use with the musical instrument 2 and a terminal “b” that is connected to the anode of the battery B1. When the plug 9 is inserted into the output jack 7, the plug input that has been formed in the vicinity of the tip of the plug 9 is brought into contact with the terminal “a.” The outer periphery of the conductor that has been formed by the body section of the plug 9 is brought into contact with the terminal “b” is connected to the grounded ring that is formed at the opening of the output jack 7. The anode of the battery B1 is grounded.

The power switch SW1 is operated by the power button 42. One terminal of the power switch SW1 is connected to the cathode of the battery B1 and the other terminal is connected to the power input of the processing circuit 12 and is connected to the cathode of the Zener diode ZD1. The anode of the Zener diode ZD1 is connected to the anode of the LED that configures the photo relay 13 through the resistor R1 and the cathode of the LED is connected to the anode of the LED that configures the photo relay 14. The cathode of that LED is grounded.

The photo relay 13 is a normally off type photo relay and in those cases where the LED is lit, that relay is off. The photo relay 14 is a normally on type photo relay and in those cases where the LED is lit, that relay is on.

Accordingly, when the battery B1 is fully charged and the power switch SW1 is turned on with the plug 9 inserted in the output jack 7, a voltage in which the Zener voltage of the Zener diode ZD1 has been subtracted from the voltage of the battery B1 is applied to the LEDs of the photo relays 13 and 14. The LEDs of the photo relays 13 and 14 light, the relay of the photo relay 13 becomes off, and the relay of the photo relay 14 becomes on.

In addition, by selecting a suitable value for the Zener voltage of the Zener diode ZD1, it is possible to set the lighting and extinguishing of the LEDs of the photo relays 13 and 14 to switch at roughly the minimum voltage at which the processing circuit 12 will operate.

One terminal of the pickup 5 is connected to one terminal of the relay of the photo relay 13 and to the input IN of the processing circuit 12 and the other terminal of the pickup 5 is grounded. The ground terminal of the processing circuit 12 is grounded, and the output OUT is connected to one terminal of the relay of the photo relay 14. The other terminal of the relay of the photo relay 13 and the other terminal of the relay of the photo relay 14 are mutually connected and are connected to the terminal 7a of the output jack 7.

Therefore, in those cases where a sufficient voltage to make the LEDs of the photo relays 13 and 14 emit light is supplied, the output of the pickup 5 is processed by the processing circuit 12 and output from the output jack 7.

On the other hand, in those cases where the voltage of the battery B1 is lower than a specified voltage (roughly the minimum voltage at which the processing circuit 12 operates normally), or in those cases where the power switch SW1 has been turned off by the power button 42, the LEDs of the photo relays 13 and 14 do not light and, as a result, the relay of the photo relay 13 becomes on while the relay of the photo relay 14 becomes off and the output of the pickup 5 is output directly to the output jack 7 via the relay of the photo relay 13.

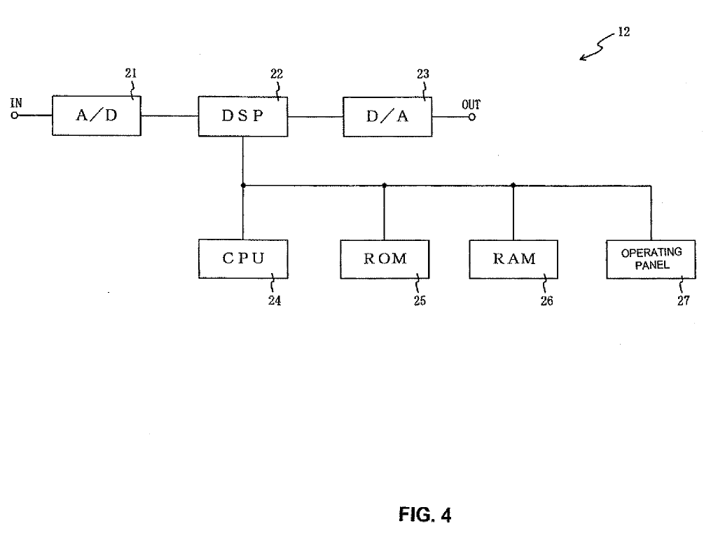

Next, an explanation will be given regarding the processing circuit 12 while referring to FIG. 4. FIG. 4 is a block diagram that shows the electrical circuit configuration of the processing circuit 12. The processing circuit 12 includes an analog-to-digital (A/D) converter 21, a digital signal processor (DSP) 22, a digital to analog (D/A) converter 23, central processing unit (CPU) 24, read only memory (ROM) 25, random access memory (RAM) 26, and the operating panel 27.

The A/D converter 21 converts the analog electrical signal in which the vibrations of the strings have been converted by the pickup 5 that has been input to the input IN into a pulse code modulation (PCM) signal, which is a digital signal. The PCM signal that has been converted is input to the DSP 22. Control programs are stored in memory that is not shown in the drawing, and the DSP carries out processing in accordance with the execution of the control programs such as adding a body resonance sound or a reverberation sound to the audio that has been input, changing the frequency characteristics of the audio signal that has been input, detecting the frequency that causes howling in those cases where the anti-feedback button 38 has been turned on and lowering the level of that frequency. The audio signal that has been processed by the DSP 22 is converted to an analog signal by the D/A converter 23 and output from the output OUT.

The CPU 24 is a microcomputer and executes the programs that are stored in the ROM 25. The CPU detects the operating state of the rotary controls and switches with which the operating panel 27 has been furnished and carries out various kinds of processing in conformance with the operating state. The RAM 26 is a memory to store various data on a temporary basis when the CPU 24 runs a program.

As has been explained above, with the preamp for use with a musical instrument 1 the power for which is supplied from the battery B1, since in those cases where the voltage of the battery B1 is normal, the photo relay 13 is off and the photo relay 14 is on, the output of the processing circuit 12 is connected to the output jack. On the other hand, since in those cases where the battery B1 has become depleted and the voltage has dropped below a specified voltage, almost no current flows to the LEDs of the photo relays 13 and 14 due to a function of a Zener diode ZD1, and the photo relay 13 changes from off to on while the photo relay 14 changes from on to off. The output of the pickup 5 that is connected to the relay of the photo relay 13 is connected directly to the output jack 7 and the output of the processing circuit 12 that is connected to the relay of the photo relay 14 is cut off. Accordingly, in those cases where the battery B1 has become depleted and a proper output cannot be obtained from the processing circuit 12, the electrical signal of the pickup 5 is output. Therefore, even in those cases where the battery B1 has become depleted during the performance, this does not bring about such impediments as the electrical signal becoming distorted or not being output.

In addition, in those cases where the power button 42 has been operated, turning the power switch SW1 off, and the power that is supplied to the processing circuit 12 has been turned off, since in the same manner, the photo relay 13 changes from off to on while the photo relay 14 changes from on to off. The output of the pickup 5 that is connected to the relay of the photo relay 13 is connected directly to the output jack 7 and the output of the processing circuit 12 that is connected to the relay of the photo relay 14 is cut off. Accordingly, the battery B1 is not depleted and, the output of the pickup 5 is output from the output jack 7.

In accordance with a preamp for use with a musical instrument according to an embodiment of the present invention, since the preamp is furnished with a battery that supplies electric power to the processing circuit and the switching device which, in those cases where the voltage of the battery has dropped below a specified voltage, switches such that the electrical signal that has been input in the input device is output from the output device instead of the output of the processing circuit, even in those cases where the battery has become depleted and a proper output cannot be obtained from the processing circuit, the electrical signal that is input in the input device is output. Therefore, there is the advantageous result that it is possible to prevent such impediments occurring as the electrical signal becoming distorted or not being output even in those cases where the battery has been depleted during the performance.

In accordance with a preamp for use with a musical instrument according to one embodiment of the present invention, since the preamp is furnished with a battery that supplies electric power to the processing circuit, a single switching device which switches such that the electrical signal that has been input in the input device is output from the output device instead of the output of the processing circuit and stops the supply of electric power to the one of two cases processing circuit by the battery, it is possible to switch with a single switch between the case in which the power from the battery is supplied to the processing circuit and the electrical signal that has been processed by the processing circuit and the case in which the power from the battery is not supplied to the processing circuit and the electrical signal that has been input in the input device is output directly, and the operability is satisfactory. In addition, there is the advantageous result that in those cases where the electrical signal that has been input in the input device is output directly, the battery is not depleted.

In an electric instrument according to an embodiment of the present invention, since the instrument is furnished with a battery that supplies electric power to the processing circuit, a switching device which, in those cases where the voltage of the battery has dropped below a specified voltage, switches such that the electrical signal that has been converted by the pickup is output from the output device instead of the output of the processing circuit, even in those cases where the battery is depleted and a proper output cannot be obtained from the processing circuit, the electrical signal that is input in the input device is output. Therefore, there is the advantageous result that even in those cases where the battery has become depleted during the performance, it is possible to prevent such impediments as the electrical signal that is output becoming distorted or not being output.

In the embodiments detailed above since the specified voltage is set roughly to the lowest operating voltage at which the processing circuit operates normally, there is the advantageous result that in those cases where the output signal from the processing circuit is output to the output device, an output that has been properly processed by the processing circuit can be obtained and in those cases where the voltage of the battery is lower than the lowest voltage at which the processing operates normally, it is possible to switch such that the electrical signal that has been input in the input device is output from the output device instead of the output of the processing circuit.

In accordance with an electric instrument according to a further embodiment of the present invention, since the instrument is furnished with a battery that supplies electric power to the processing circuit, a switching device which switches such that the electrical signal that has been converted by the pickup is output from the output device instead of the output of the processing circuit and stops the supply of electric power to the processing circuit by the battery, it is possible to switch with a single switch between the case in which power from the battery is supplied to the processing circuit and the electrical signal that has been processed by the processing circuit is output and the case in which power from the battery is not supplied to the processing circuit and the electrical signal that has been input in the input device is output directly. The operability is satisfactory. In addition, there is the advantageous result that in those cases where the electrical signal that has been input in the input device is output directly, the battery is not depleted.

In the embodiments detailed above, since the processing circuit is furnished with a level adjustment device that adjusts the output level of the electrical signal that has been input in the input device or of the electrical signal that has been converted by the pickup, there is the advantageous result that it is possible to adjust the level of the output of the processing circuit.

In the embodiments detailed above, since the processing circuit is furnished with an effect imparting device that imparts a specific effect to the electrical signal that has been input in the input device or to the electrical signal that has been converted by the pickup, there is the advantageous result that it is possible to impart a specific effect to the electrical signal that has been input in the input device.

Also, since the processing circuit is furnished with a frequency characteristics changing device that changes the frequency characteristics of the electrical signal that has been input in the input device or of the electrical signal that has been converted by the pickup, there is the advantageous result that it is possible to change the frequency characteristics of the electrical signal that has been input in the input device.

An explanation was given above of the present invention based on several embodiments. However, the present invention is in no way limited to these embodiments described above and the fact that various modifications and changes are possible that do not deviate from and are within the scope of the essentials of the present invention can be easily surmised.

For example, in one embodiment of the present invention a coil type relay that can switch on and off by an electric current may be used instead of the photo relays 13 and 14.

In addition, in an embodiment of the present invention described above, the preamp for use with a musical instrument 2 is installed in the acoustic guitar 1 but the preamp for use with a musical instrument 2 may be an independent unit that is not installed in an electric instrument.

In addition, in an embodiment of the present invention described above, the designation of “preamp for use with a musical instrument” has been used. However, the unit may also be called a so-called effector, or an effector for use with an electric guitar, or an effector for use with an electric bass.

In addition, in an embodiment of the present invention described above, the pickup 5 has been made a piezoelectric type but it may also be made a of single coil type, a humbucking type, or an ordinary microphone.

1. A preamp for use with a musical instrument, comprising:
input means for inputting an electrical signal;
a processing circuit for processing the electrical signal;
output means for outputting the electrical signal to an external device;
a battery that supplies electric power to the processing circuit; and
switching means for automatically switching, in cases where a voltage of the battery has dropped below a specified voltage, such that the electrical signal that was input on the input means is output from the output means directly instead of an output of the processing circuit.

2. The preamp for use with a musical instrument according to claim 1, wherein the specified voltage is a lowest operating voltage at which the processing circuit operates normally.

3. (canceled)

4. The preamp for use with a musical instrument according to claim 1, wherein the processing circuit further includes level adjustment means for adjusting an output level of the electrical signal.

5. The preamp for use with a musical instrument according to claim 1, wherein the processing circuit further includes effect imparting means for imparting a specific effect to the electrical signal.

6. The preamp for use with a musical instrument according to claim 1, wherein the processing circuit further includes frequency characteristics changing means for changing frequency characteristics of the electrical signal.

7. An electric instrument, comprising:
a plurality of strings;
a pickup that is arranged facing the strings and converts vibrations of the strings into an electrical signal;
a processing circuit that inputs and processes the electrical signal that has been converted by the pick up;
an output for outputting the electrical signal;
a battery that supplies electric power to the processing circuit; and
switching structure for automatically switching, in those cases where a voltage of the battery has dropped below a specified voltage, such that the electrical signal from the pickup is provided directly to the output instead of from the processing circuit.

8. The electric instrument according to claim 7, wherein the specified voltage is a lowest operating voltage at which the processing circuit operates normally.

9. (canceled)

10. The electric instrument according to claim 7, wherein the processing circuit further includes level adjustment means for adjusting an output level of the electrical signal that has been converted by the pickup.

11. The electric instrument according to claim 7, wherein the processing circuit further includes effect imparting means for imparting a specific effect to the electrical signal that has been converted by the pickup.

12. The electric instrument according to claim 7, wherein the processing circuit further includes frequency characteristics changing means for changing frequency characteristics of the electrical signal that has been converted by the pickup.

13. A preamp for use with a musical instrument, comprising:
a processing circuit that processes an electrical signal;
an output device that outputs the electrical signal to an external device;
a battery that supplies electric power to the processing circuit, and
a switch that automatically switches in those cases where a voltage of the battery has dropped below a specific voltage, such that the electrical signal is output from the output device directly instead of an output of the processing circuit.

14. The preamp for use with a musical instrument according to claim 13, wherein the specified voltage is a lowest operating voltage at which the processing circuit operates normally.

15. The preamp for use with a musical instrument according to claim 13, wherein the processing circuit further includes a level adjustment device that adjusts the output level of the electrical signal.

16. The preamp for use with a musical instrument according to claim 13, wherein the processing circuit further includes an effect imparting device that imparts a specific effect to the electrical signal.

17. A method for amplifying a signal of a musical instrument, comprising:
processing an electrical signal;
outputting the processed signal to an external device;
supplying electric power to a processing circuit that processes the electrical signal; and
switching automatically, in those cases where a voltage has dropped below a specified voltage such that the electrical signal is output directly to the external device instead of an output of the processing circuit.

18. The method according to claim 17, further comprising specifying a voltage as a lowest operating voltage at which the processing circuit operates normally.

19. The method according to claim 17, further comprising adjusting an output level of the electrical signal.

20. The method according to claim 17, further comprising imparting a specific effect to the electrical signal.

21. The preamp for use with a musical instrument according to claim 1, wherein the switching means comprises electronics responsive to a battery voltage that is below the specified voltage for controlling the switching means to switch to the state in which the electrical signal is output from the output means instead of the processing circuit.

22. The preamp for use with a musical instrument according to claim 21, wherein the electronics responsive to a battery voltage that is below the specified voltage comprises:
a voltage reducing device coupled in electrical communication with the battery, to provide a voltage output that is reduced by a specified amount from the battery voltage;
a signal emitting device coupled in electrical communication with the voltage reducing device and configured to emit a signal upon receipt of a voltage signal above a pre-define voltage level; and
a signal receiving device coupled to receive a signal from the signal emitting device and to control the state of a switch based on whether or not the signal was received by the signal receiving device.

23. The preamp for use with a musical instrument according to claim 22, wherein the signal emitting device comprises a light emitting device and the signal receiving device comprises a light detecting device.

24. The preamp for use with a musical instrument according to claim 22, wherein the processing circuit is coupled in electrical communication with the battery through a path of electrical conduction that is free of the voltage reducing device.

25. The preamp for use with a musical instrument according to claim 7, wherein the switching structure comprises electronics responsive to a battery voltage that is below the specified voltage for controlling the switching structure to switch to the state in which the electrical signal is output from the output means instead of the processing circuit.

26. The preamp for use with a musical instrument according to claim 25, wherein the electronics responsive to a battery voltage that is below the specified voltage comprises:
a voltage reducing device coupled in electrical communication with the battery, to provide a voltage output that is reduced by a specified amount from the battery voltage;
a signal emitting device coupled in electrical communication with the voltage reducing device and configured to emit a signal upon receipt of a voltage signal above a pre-define voltage level; and
a signal receiving device coupled to receive a signal from the signal emitting device and to control the state of a switch based on whether or not the signal was received by the signal receiving device.

27. The preamp for use with a musical instrument according to claim 26, wherein the signal emitting device comprises a light emitting device and the signal receiving device comprises a light detecting device.

28. The preamp for use with a musical instrument according to claim 26, wherein the processing circuit is coupled in electrical communication with the battery through a path of electrical conduction that is free of the voltage reducing device.
